(19) United States
(12) Patent Application Publication
(10) Pub. No.: US 2009/0132979 A1
(43) Pub. Date: May 21, 2009

(54) DYNAMIC POINTER DEREFERENCING AND CONVERSION TO STATIC HARDWARE

(76) Inventors: Simon Joshua Waters, Newberg, OR (US); Peter Pius Gutberlet, Wilsonville, OR (US)

Correspondence Address: KLARQUIST SPARKMAN, LLP, 121 S.W. SALMON STREET, SUITE 1600, PORTLAND, OR, 97204, US

(21) Appl. No.: 12/274,168

(22) Filed: Nov. 19, 2008

Related U.S. Application Data
(60) Provisional application No. 60/989,092, filed on Nov. 19, 2007.

(51) Int. Cl. G06F 17/50

(52) U.S. Cl. 716/5; 716/18

(57) ABSTRACT

Disclosed herein are embodiments of methods and apparatus for handling dynamic pointers during algorithmic synthesis. In one disclosed embodiment, a high-level description of a circuit design (e.g., C++ description or a parsed C++ description) is received. In this embodiment, the high-level description comprises one or more dynamic pointer dereferencing operations. The high-level description of the circuit is converted into an RTL description or a gate-level netlist. In this embodiment, the RTL description or the gate-level netlist describes hardware capable of implementing the dynamic pointer dereferencing operations. The hardware can comprise, for instance, one or more multiplexers and/or one or more demultiplexers.

### CROSS-REFERENCE TO RELATED APPLICATIONS

This application claims the benefit of U.S. Provisional Application No. 60/989,092, filed Nov. 19, 2007, which is hereby incorporated herein by reference.

### FIELD

This application relates generally to the field of converting a high-level description of a circuit design (e.g., an algorithmic description in C++) into a lower-level description (e.g., a register transfer level description).

### BACKGROUND

The design of complex computer hardware no longer begins with a circuit diagram. Instead, it begins with a software program that describes the behavior or functionality of a circuit. This software program is sometimes written in a hardware description language (“HDL”) (e.g., VHDL or Verilog) that defines an algorithm to be performed with limited implementation details. Designers then use behavioral synthesis tools to convert the HDL into a register transfer level (“RTL”) description. The RTL description is used to generate a netlist that includes a list of components in the circuit and the interconnections between the components. This netlist is ultimately used to create the physical integrated circuit.

Although describing a system design in HDL provides some flexibility to designers, it is desirable to allow a designer to describe a circuit's desired functionality at an even greater level of abstraction. For example, it is desirable to allow designers to describe circuit behavior in programming languages like C and C++. The description of the circuit in C or C++ can then be synthesized by synthesis tools (sometimes termed algorithmic synthesis tools) used to generate an RTL description of the circuit.

In order to properly implement the desired functionality specified by the designer, it is important that the algorithmic synthesis tool properly account for and convert into hardware certain operations commonly used in C or C++ programming languages. For example, the use of pointers and dereferencing operations is common among C++ programmers. Unfortunately, conventional algorithmic synthesis tools do not provide full support for pointers. For example, many conventional algorithmic synthesis tools can only convert pointers that point to a single object (“static pointers”). Consequently, there is a need for improved methods of converting algorithmic circuit descriptions having pointers that point to two or more objects (“dynamic pointers”).

### SUMMARY

Disclosed herein are representative embodiments of methods and apparatus for handling dynamic pointers during algorithmic synthesis. The disclosed methods and apparatus should not be construed as limiting in any way. Instead, the present disclosure is directed toward all novel and nonobvious features and aspects of the various disclosed embodiments, alone and in various combinations and subcombinations with one another. The methods and apparatus are not limited to any specific aspect, feature, or combination thereof, nor do the disclosed methods require that any one or more specific advantages be present or problems be solved.

In certain disclosed embodiments, an algorithmic description of a circuit design is received (e.g., loaded or buffered). In these embodiments, the algorithmic description comprises one or more dereferencing operators, where each dereferencing operator is associated with a pointer variable. Addressable objects in the algorithmic description are identified and assigned unique values. One or more statements describing hardware for implementing the one or more dereferencing operators are generated. The one or more statements are stored on a computer-readable medium. In certain embodiments, the act of generating the hardware involves using the unique values assigned to the addressable objects. Furthermore, in particular embodiments, the hardware comprises at least one multiplexer or at least one demultiplexer. The algorithmic description can be a C++ description or a parsed C++ description. The addressable objects may include, for example, scalar variables, array variables, and/or pointer variables. In particular implementations, an inclusive multiplexer statement for a selected one of the dereferencing operators is generated, the inclusive multiplexer statement describing a multiplexer capable of outputting values associated with any of the addressable objects. The inclusive multiplexer statement can be optimized by removing parameters of the inclusive multiplexer statement that are not valid. In certain implementations, one of the dereferencing operators is used in an assignment of one or more values to variables pointed to by the associated pointer variable, and an inclusive multiplexer statement is generated for the assignment. In these implementations, the inclusive multiplexer statement can describe a demultiplexer capable of outputting the one or more values to memory addresses associated with any of the addressable objects. The inclusive multiplexer statement can be optimized by removing parameters of the inclusive multiplexer statement that are not valid. In further implementations, a statement for a selected one of the dereferencing operators is generated, the statement including a temporary object that indicates an instance of a dereferencing operation for the associated pointer variable. In these implementations, the temporary object in the statement can be replaced with a multiplexer statement or demultiplexer statement. In some implementations, the algorithmic description further comprises a pointer variable that points to other pointer variables and a dereferencing operation that twice dereferences the pointer variable that points to other pointer variables. In such implementations, one or more statements describing hardware for implementing the dereferencing operation that twice dereferences the pointer variable that point to other pointer variables are generated, the hardware comprising two or more multiplexers. For any of the implementations, the statements can be converted into a register transfer level (“RTL”) circuit description. The RTL circuit description can be converted into a gate-level netlist. An integrated circuit can be manufactured from the gate-level netlist, wherein the integrated circuit comprises the at least one multiplexer or the at least one demultiplexer.

In other disclosed embodiments, one or more computer readable media storing computer-executable instructions for causing a computer to perform a method are described. In these embodiments, the method comprises converting an algorithmic description of desired circuit functionality (e.g., a C++ description or a parsed C++ description) into a register transfer level (“RTL”) description of a circuit for implementing the desired circuit functionality, wherein the algorithmic description of the desired circuit functionality comprises one or more pointer dereferencing operations, and wherein a portion of the RTL description defines one or more multiplexers for implementing at least one of the pointer dereferencing operations; and storing the RTL description of the circuit on a computer-readable medium. In particular implementations, the converting comprises converting the algorithmic description into an intermediate description, the intermediate description comprising one or more statements defining the one or more multiplexers. In some implementations, the converting comprises generating a hardware description statement describing a multiplexer for a selected one of the dereferencing operations, the selected dereferencing operation being associated with a respective pointer. The hardware description statement can be optimized so that the multiplexer described by the hardware description statement is capable of selecting only those values that correspond to variables actually pointed to by the respective pointer. In other implementations, the converting comprises generating a hardware description statement for a selected one of the dereferencing operations, the selected dereferencing operation being associated with a respective pointer, the hardware description statement including a temporary object that indicates an instance of the dereferencing operation is to occur. The temporary object in the statement can be replaced with a hardware description of a multiplexer capable of selecting only those values that correspond to variables actually pointed to by the respective pointer. In particular implementations, the algorithmic description further comprises a pointer to pointer variable and a dereferencing operation that twice dereferences the pointer to pointer variable. In these implementations, a statement describing two or more multiplexers can be generated for implementing the dereferencing operation that twice dereferences the pointer to pointer variable. For any of these implementations, the RTL circuit description can be converted into a gate-level netlist.

In other disclosed embodiments, one or more computer readable media storing computer-executable instructions for causing a computer to perform another method are described. In these embodiments, the method comprises converting an algorithmic description of desired circuit functionality (e.g., C++ description or a parsed C++ description) into a register transfer level (“RTL”) description of a circuit for implementing the desired circuit functionality, wherein the algorithmic description of the desired circuit functionality comprises one or more pointer dereferencing operations, and wherein a portion of the RTL description defines one or more demultiplexers for implementing at least one of the pointer dereferencing operations; and storing the RTL description of the circuit on a computer-readable medium. In particular implementations, the converting comprises converting the algorithmic description into an intermediate description, the intermediate description comprising one or more statements defining the one or more demultiplexers. In certain implementations, the converting comprises generating a hardware description statement describing a demultiplexer for a selected one of the dereferencing operations, the selected dereferencing operation being associated with a respective pointer. The hardware description statement can be optimized so that the demultiplexer described by the hardware description statement is capable of outputting one or more values to memory addresses associated with only those variables that are actually pointed to by the respective pointer. In some implementations, the converting comprises generating a hardware description statement for a selected one of the dereferencing operations, the selected dereferencing operation being associated with a respective pointer, the hardware description statement including a temporary object that indicates an instance of the dereferencing operation is to occur. The temporary object in the statement can be replaced with a hardware description of a demultiplexer capable of outputting one or more values to memory addresses associated with only those variables that are actually pointed to by the respective pointer. In particular implementations, the algorithmic description further comprises a pointer to pointer variable and a dereferencing operation that twice dereferences the pointer to pointer variable. In these implementations, a statement describing two or more demultiplexers can be generated for implementing the dereferencing operation that twice dereferences the pointer to pointer variable. For any of these implementations, the RTL circuit description can be converted into a gate-level netlist.

In other disclosed embodiments, one or more computer readable media storing computer-executable instructions for causing a computer to perform another method are described. In these embodiments, the method comprises receiving a high-level description of a circuit design (e.g., C++ description or a parsed C++ description), the high-level description comprising one or more dynamic pointer dereferencing operations; and converting the high-level description of the circuit into an RTL description or a gate-level netlist, the RTL description or the gate-level netlist describing hardware capable of implementing the dynamic pointer dereferencing operations. The hardware can comprise one or more multiplexers and/or one or more demultiplexers. In certain implementations, the high-level description can be converted into an intermediate description, the intermediate description comprising one or more statements that define the one or more multiplexers or demultiplexers for implementing the pointer dereferencing operations.

Any of the disclosed methods may be performed by a computer program, such as an electronic-design-automation (“EDA”) software tool, comprising computer-executable instructions stored on one or more computer-readable media. Further, any of the disclosed methods can be used to create circuit design information stored on one or more computer-readable media. The circuit design information can comprise, for example, an RTL description of the circuit, an intermediate format description of the circuit (such as a synthesis intermediate format (“SIF”) description), or a gate-level netlist.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a flowchart showing an exemplary algorithmic synthesis flow as can be used in connection with embodiments of the disclosed technology.

FIG. 2 is an example of a C++ description including a pointer dereferencing operation.

FIG. 3 is a flowchart showing a first exemplary method for converting an algorithmic description with one or more pointers into a lower-level description.

FIG. 4A shows a first example C++ description.

FIG. 4B shows a memory map generated by applying the method of FIG. 3 to the first example C++ description.

FIG. 4C shows an initial intermediate format description generated by applying the method of FIG. 3 to the first example C++ description.

FIG. 4D shows an optimized intermediate format description generated by applying the method of FIG. 3 to the first example C++ description.

FIG. 4E is a schematic block diagram of hardware corresponding to the statement in the optimized intermediate format performing the dereferencing operation.

FIG. 5A shows a second example C++ description.

FIG. 5B shows a memory map generated by applying the method of FIG. 3 to the second example C++ description.

FIG. 5C shows an initial intermediate format description generated by applying the method of FIG. 3 to the second example C++ description.

FIG. 5D shows an optimized intermediate format description generated by applying the method of FIG. 3 to the second example C++ description.

FIG. 5E is a schematic block diagram of hardware corresponding to the statement in the optimized intermediate format of FIG. 5D performing the dereferencing operation.

FIG. 6A shows a third example C++ description.

FIG. 6B shows a memory map generated by applying the method of FIG. 3 to the third example C++ description.

FIG. 6C shows an initial intermediate format description generated by applying the method of FIG. 3 to the third example C++ description.

FIG. 6D shows an optimized intermediate format description generated by applying the method of FIG. 3 to the third example C++ description.

FIG. 6E is a schematic block diagram of hardware corresponding to the statement in the optimized intermediate format of FIG. 6D performing the dereferencing operation.

FIG. 7A shows a fourth example C++ description.

FIG. 7B shows a memory map generated by applying the method of FIG. 3 to the fourth example C++ description.

FIG. 7C shows an initial intermediate format description generated by applying the method of FIG. 3 to the fourth example C++ description.

FIG. 7D shows an optimized intermediate format description generated by applying the method of FIG. 3 to the fourth example C++ description.

FIG. 7E is a schematic block diagram of hardware corresponding to the statement in the optimized intermediate format of FIG. 7D performing the dereferencing operation.

FIG. 8A shows a fifth example C++ description.

FIG. 8B shows a memory map generated by applying the method of FIG. 3 to the fifth example C++ description.

FIG. 8C shows an initial intermediate format description generated by applying the method of FIG. 3 to the fifth example C++ description.

FIG. 8D shows an optimized intermediate format description generated by applying the method of FIG. 3 to the fifth example C++ description.

FIG. 8E is a schematic block diagram of hardware corresponding to the statement in the optimized intermediate format of FIG. 8D performing the dereferencing operation.

FIG. 9 is a flowchart showing a second exemplary method for converting an algorithmic description with one or more pointers into a lower-level description.

FIG. 10A shows a sixth example C++ description.

FIG. 10B shows a memory map generated by applying the method of FIG. 9 to the sixth example C++ description.

FIG. 10C shows an initial intermediate format description generated by applying the method of FIG. 9 to the sixth example C++ description.

FIG. 10D shows an optimized intermediate format description generated by applying the method of FIG. 9 to the sixth example C++ description.

FIG. 10E is a schematic block diagram of hardware corresponding to the statement in the optimized intermediate format of FIG. 10D performing the dereferencing operation.

FIG. 11 is a schematic block diagram of a first distributed computing network that can be used to generate test patterns according to the disclosed technology.

FIG. 12 is a schematic block diagram of a second distributed computing network that can be used to generate test patterns according to the disclosed technology.

FIG. 13 is a flowchart of a method for producing test patterns using a distributed computing networks, such as the networks of FIGS. 11 and 12.

### DETAILED DESCRIPTION

### I. General Considerations

Disclosed below are representative embodiments of methods and apparatus for performing synthesis of a high-level description of circuit behavior into a lower-level description. In particular, the representative embodiments involve the synthesis of a C++ or C-type description of a circuit into an RTL or gate-level description where the C++ or C-type description includes one or more dynamic pointers. The disclosed methods and apparatus should not be construed as limiting in any way. Instead, the present disclosure is directed toward all novel and nonobvious features and aspects of the various disclosed embodiments, alone and in various combinations and subcombinations with one another. The methods and apparatus are not limited to any specific aspect or feature or combinations thereof, nor do the disclosed methods require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “evaluate” and “generate” to describe the disclosed methods. These terms are high-level abstractions of the actual operations that are performed. The actual operations that correspond to these terms may vary depending on the particular implementation and are readily discernible by one of ordinary skill in the art.

The disclosed technology can be applied during synthesis of an integrated circuit design (e.g., synthesis of a C++ description of circuit behavior into an RTL or gate-level description (sometimes referred to as “algorithmic synthesis”)). Embodiments of the disclosed technology, for example, produce an RTL description or gate-level netlist suitable for implementing a wide variety of integrated circuits (e.g., application-specific integrated circuits (“ASIC”), programmable logic devices (“PLDs”), systems-on-a-chip (“SoCs”), or microprocessors).

Any of the disclosed methods can be performed using software stored on one or more computer-readable storage media (e.g., nonvolatile memory, such as an optical media disc or a hard drive, or volatile memory, such as any type of RAM) and executed on a computer (e.g., any commercially available general purpose computer comprising one or more microprocessors for executing the stored computer-executable instructions). Such software can comprise, for example, an electronic-design-automation (“EDA”) software tool used, for instance, for or in connection with algorithmic synthesis. One exemplary software tool is the CATAPULT® C Synthesis tool available from Mentor Graphics Corporation. Such software can be executed on a single computer or on a networked computer (e.g., via the Internet, a wide-area network, a local-area network, a client-server network, or other such network).

Furthermore, such software (comprising computer-executable instructions for causing a computer to perform any of the disclosed methods) can be transmitted, received, or accessed through a suitable communication means. Similarly, one or more circuit descriptions, design files, data structures, intermediate results, or final results (e.g., a portion or all of an RTL description, SIF description, or gate-level netlist) created or modified using any of the disclosed methods can be transmitted, received, or accessed through a suitable communication means. Such suitable communication means include, for example, the Internet, the World Wide Web, an intranet, software applications, cable, magnetic, electronic communications, or other communications means.

Any circuit description, design file, data structure, intermediate result, or final result (e.g., a portion or all of an RTL description, SIF description, or gate-level netlist) produced by any of the disclosed methods can be displayed to a user using a suitable display device (e.g., a computer monitor). Such displaying can be performed as part of a computer-implemented method of performing any of the disclosed methods.

For clarity, only certain selected aspects of the software-based implementations are described. Other details that are well known in the art are omitted. For example, it should be understood that the disclosed technology is not limited to any specific computer language, program, or computer. For this same reason, computer hardware that can be used to execute the computer-readable instructions is not described in further detail.

Any of the disclosed methods can also be used to modify or create a circuit represented as circuit design information stored on one or more computer-readable media. As noted, the circuit design information can comprise, for example, one or more design files or data structures (e.g., an RTL description, SIF description, or gate-level netlist) and may be created or modified on a single computer or via a network.

### II. Introduction to Disclosed Technology

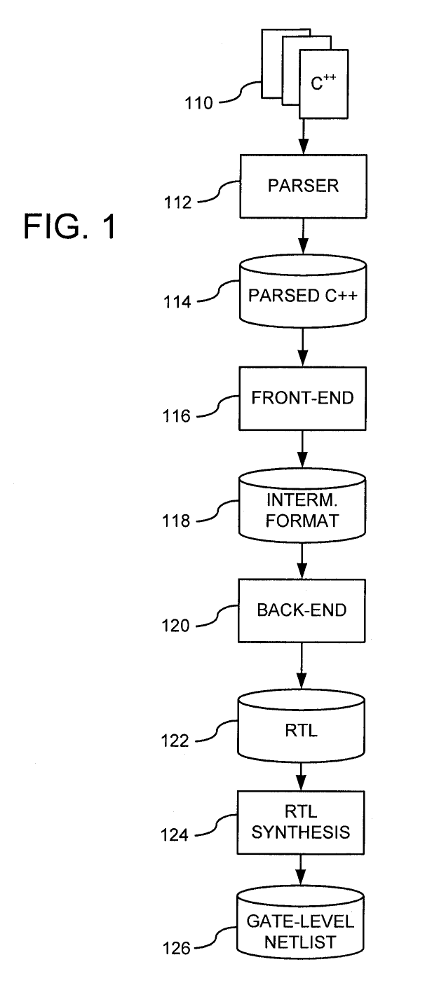

FIG. 1 is a flowchart 100 schematically illustrating an exemplary algorithmic synthesis flow according to an embodiment of the disclosed technology. The exemplary flow shown in FIG. 1 should not be construed as limiting in any way. For example, in other embodiments of the disclosed technology, only a subset of the illustrated method acts are performed. In still other embodiments, the method acts are performed alone or in other combinations and subcombinations with one another or with other synthesis acts.

At 110, a C++ description of desired circuit behavior is received (e.g., loaded or buffered into memory). The C++ description can be a pure ANSI C++ description but can also comprise other formats or C-type descriptions. Still further, the description at 110 can comprise any suitable high-level programming language description supporting pointers. For presentation purposes, the remainder of the disclosure will refer to a C++ description, though it is to be understood that all other types of high-level descriptions supporting pointers are also possible and envisioned as within the scope of the present disclosure.

At 112, the C++ description is parsed. A wide variety of suitable parsers can be used, but in one exemplary implementation the C++ front end tool available from Edison Design Group is used. In this particular implementation, the C++ front end translates source code into a high-level, tree-structured, in-memory intermediate language. The intermediate language preserves much of the source information, including line numbers, column numbers, original types, and original names. Furthermore, in this particular implementation, the parser generates a data structure that lists the identity of the addressable objects in the original C++ description.

In the illustrated embodiment, the C++ parser generates one or more intermediate data structures 114 storing an intermediate language C++ description and, in some cases, additional files providing further information about the original C++ description. These data structures are generally referred to herein as the “parsed C++ ”.

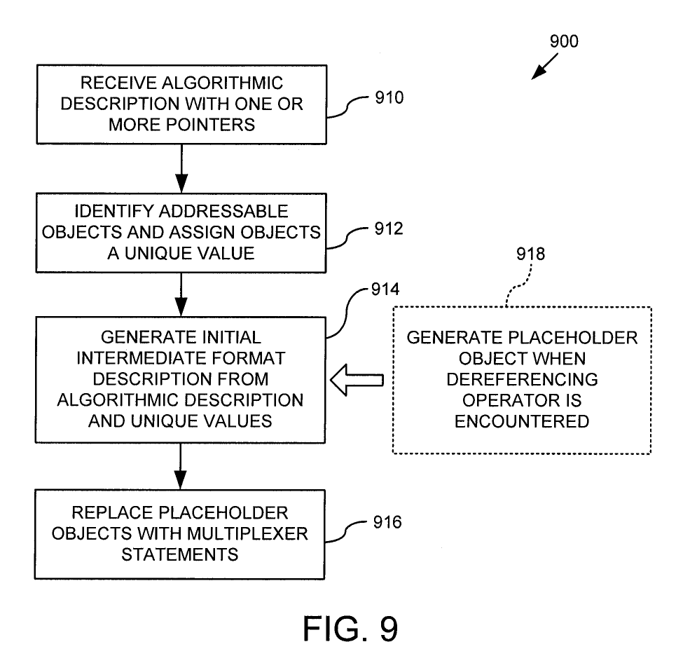

At 116, the parsed C++ is received (e.g., loaded or buffered into memory) by a C++ synthesis front-end component. In the illustrated embodiment, the front-end component translates the intermediate language description into an intermediate format termed the “synthesis intermediate format” or “SIF,” which comprises a high-level description that can more easily be synthesized into an RTL description. For example, in embodiments of the disclosed technology, the SIF description is highly similar to VHDL and can be synthesized into RTL using RTL synthesis back-end tools. In other embodiments, the intermediate format can be similar or identical to other types of hardware description languages (e.g., SystemVerilog, Verilog, and other such hardware description languages). As more fully explained below, one aspect of converting the parsed C++ into a SIF description is an analysis and appropriate conversion of the variables and statements contained within the parsed C++ description. In certain embodiments of the disclosed technology, for instance, the variables (or other objects that can be mapped into memory) in the parsed C++ description are identified and assigned a unique value (e.g., using a so-called “memory map,” which is explained in greater detail below), and the statements in the parsed C++ description are converted into corresponding SIF statements, thereby creating a new representation of the algorithm described by the original C++ description. As more fully explained below, the parsed C++ description may contain C++ data types and operations that require special conversion considerations. In particular, “pointers” in the parsed C++ description need to be properly accounted for and converted into appropriate SIF statements such that the design intent from the original C++ is preserved. Exemplary embodiments for handling pointers in the parsed C++ description and original C++ description are described below in FIGS. 3 and 9 and the accompanying examples. The exemplary embodiments can be implemented as part of the front-end components of the CATAPULT® C Synthesis tool available from Mentor Graphics Corporation. In the illustrated embodiment, the C++ synthesis front end component generates a SIF data structure 118.

At 120, the SIF data structure is received (e.g., loaded or buffered into memory) by a C++ synthesis back-end component. The back-end component converts the SIF data structure into an RTL description, such as VHDL RTL. The back-end components can comprise, for example, the back-end components of the CATAPULT® C Synthesis tool available from Mentor Graphics Corporation. In the illustrated embodiment, the C++ synthesis back end component generates an RTL data structure 122.

In particular embodiments, the C++ parser, synthesis front-end, and synthesis back-end components can be part of a single tool that performs the described method acts automatically without user interaction. In other embodiments, however, the method acts 112, 116, 120 are performed by separate tools, in various other combinations and subcombinations with one another, or with different degrees of user interaction.

At 124, the RTL data structure is received (e.g., loaded or buffered into memory) by an RTL synthesis tool. The RTL synthesis tool converts the RTL data structure into a gate-level netlist. The gate-level netlist can be a netlist suitable for a variety of different circuit architectures, such as application-specific integrated circuits (“ASIC”), programmable logic devices (“PLDs”) (including field programmable gate arrays (“FPGAs”), systems-on-a-chip (“SoCs”), or microprocessors. In the illustrated embodiment, the RTL synthesis tool generates a gate-level netlist 126.

### III. Exemplary Embodiments for Converting C++ Pointers

A. Brief Introduction to Pointers

A “pointer” is a well known data type used in C++ and other programming languages whose value refers directly to another value stored elsewhere. For example, a C++ pointer is typically a variable that stores the value of a memory address, the memory address being for the memory that holds the value to which the pointer refers or “points”. Furthermore, the variable can be defined as a single pointer or an array of pointers in which each element of the array is itself a pointer. The act of obtaining the value at the address to which a pointer points is called “dereferencing” the pointer.

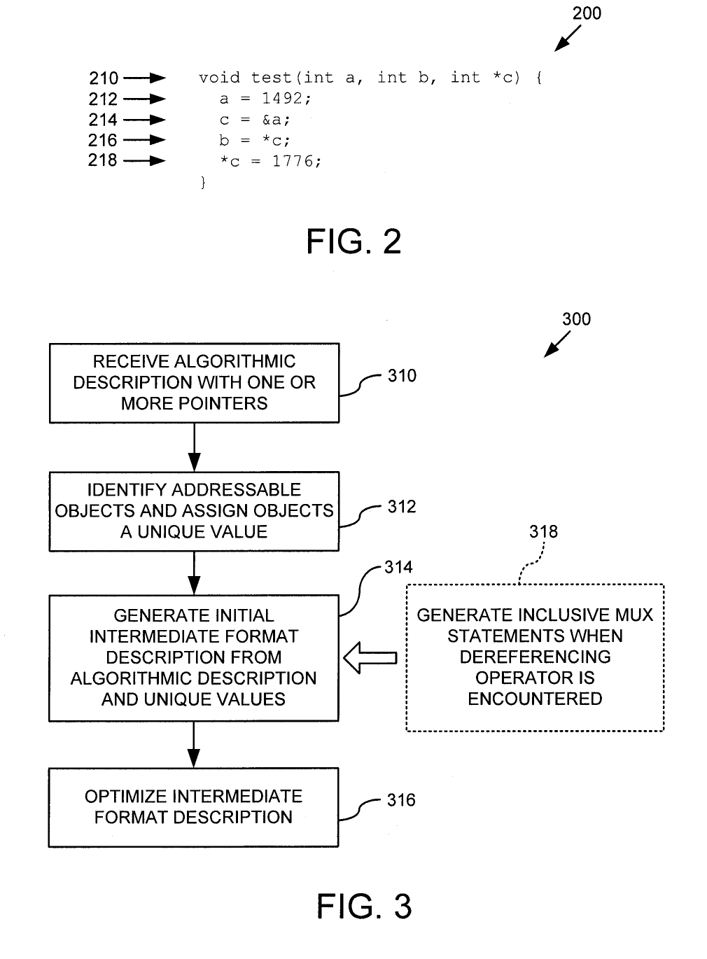

FIG. 2 shows exemplary C++ code 200, which illustrates a few properties of pointers. At 210, the example C++ code 200 shown in FIG. 2 indicates the declaration of two integer variables “a” and “b” and one integer pointer “c”. (“*” typically denotes the dereference operator and can be thought of conceptually as translating to “the value pointed to by”. When used in a declaration statement as in line 210, however, the “*” merely indicates that the variable being declared is a pointer.) For purposes of this example, assume that the memory addresses eventually assigned to the variables are 0x0001 for variable a, 0x0002 for variable b, and 0x0003 for pointer c.

At 212, the code 200 indicates that variable a is to be assigned the value “1492”. Thus, during execution, the value “1492” is assigned to the memory at memory address 0x0001. At 214, pointer c is assigned the address of variable a. Thus, during execution, the value “0x0001” is assigned to the memory at memory address 0x0003. (“&” denotes the reference operator and can be thought of conceptually as translating to “the address of”.) At 216, variable b is assigned the dereferenced value of pointer c. In other words, during execution, the value pointed to by c is assigned to the memory address of variable b. Thus, the value of “1492” is assigned to the memory at memory address 0x0002. At 218, the variable pointed to by c is reassigned to the value “1776”. That is, during execution, the memory at memory address 0x0001 (variable a) is assigned a new value “1776,” replacing the old value of “1492”.

B. Exemplary Embodiments for Converting Pointers

FIG. 3 is a flow chart illustrating an exemplary method 300 for handling pointers during the conversion process. The illustrated embodiment results in a conversion of the C++ description containing the pointers into a corresponding SIF description, but it should be understood that the principles underlying the conversion process can be readily applied to other conversion processes, such as C++ to VHDL description or other HDL description. The exemplary method shown in FIG. 3 should not be construed as limiting in any way. For example, in other embodiments of the disclosed technology, only a subset of the illustrated method acts are performed. In still other embodiments, any of the method acts are performed alone or in other combinations and subcombinations with one another or with other synthesis acts.

At 310, an algorithmic description (e.g., a C++ description) including one or more pointers is received (e.g., loaded or buffered into memory). In particular implementations, a parsed C++ description is received. The algorithmic description may comprise a single procedure or may comprise a plurality of procedures.

At 312, the addressable objects in the algorithmic description (e.g., a C++ description) are identified and assigned a unique value. For example, this identification and assignment process can be performed as part of a first pass through the parsed C++ description. As noted, in particular implementations, the parser generates a data structure identifying addressable objects of the C++ description (e.g., the variables in the C++ description). For instance, the C++ parser available from Edison Design Group provides such a data structure. In these implementations, the data structure can be evaluated to identify the addressable objects. In other implementations, the lines of the C++ description can be sequentially evaluated for the presence of an addressable object. The addressable objects identified during this process can include, for example, scalar variables, array variables, and pointer variables.

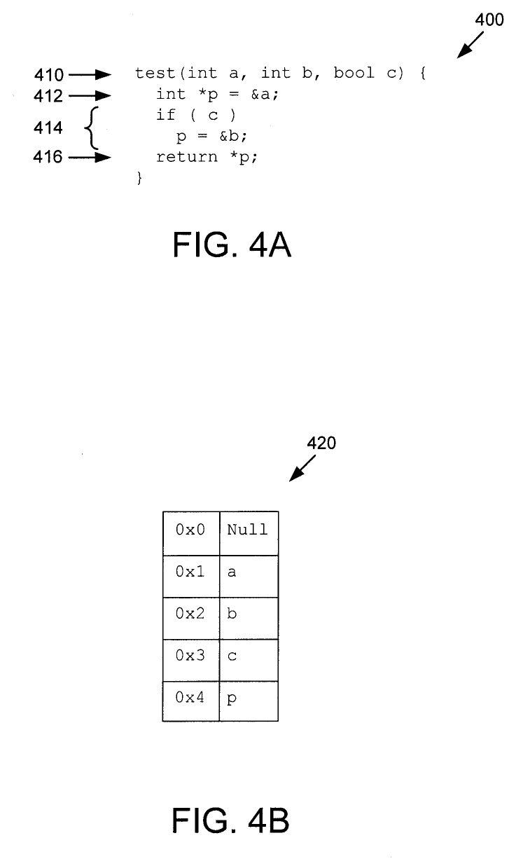

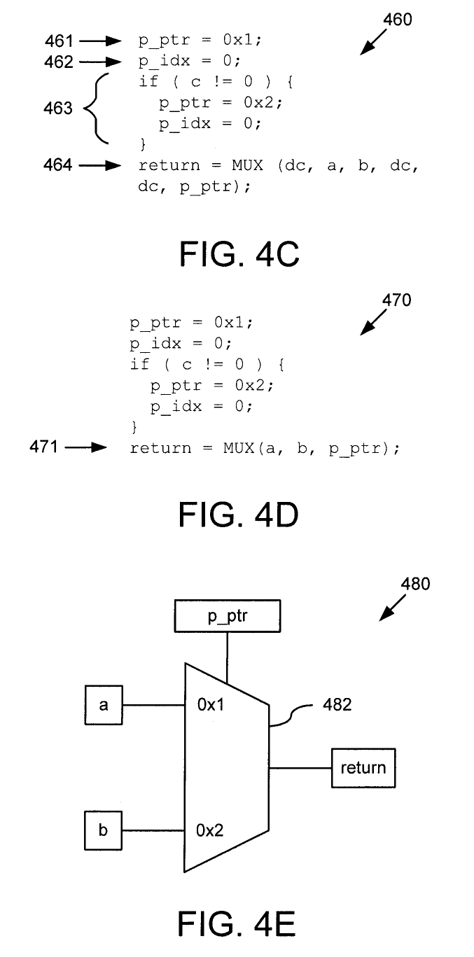

The addressable objects are also assigned a unique value during method act 312. The addressable object and the unique value assigned to each addressable object can be stored in a so-called “memory map”. The memory map can comprise, for example, a dictionary or hash table. In particular embodiments, the memory map is built by assigning a unique address (e.g., 0x1, 0x2, . . . ,N) to each addressable object encountered in the parsed C++ description. Furthermore, in particular implementations, the memory map includes a dedicated address (e.g., 0x0) for the null pointer. Examples of memory maps created during method act 312 are shown in FIGS. 4B, 5B, 6B, 7B, 8B, and 10B discussed below. The memory map does not typically indicate the actual memory locations in a circuit architecture where the values for the addressable objects are to be stored, as the actual memory locations (e.g., in an embedded memory array) are typically assigned during a later synthesis process.

At 314, an initial intermediate format description of the algorithmic description is generated. For example, in particular embodiments, initial synthesis intermediate format (“SIF”) statements representing the C++ description are generated. The initial SIF statements can be generated as part of a second pass through the C++ description. In particular implementations, each line of the C++ description is sequentially evaluated and converted into one or more corresponding intermediate format statements. In the examples shown in FIGS. 4C, 5C, 6C, 7C, 8C, and 10C, the intermediate format statements are SIF statements, though the statements can correspond to other suitable HDL statements (e.g., VHDL statements and the like).

In certain embodiments, when a pointer assignment is encountered as part of method act 314, a SIF statement assigning the pointer variable to the address of the assigned object is generated. Furthermore, in particular embodiments, an additional SIF statement creating an object for indexing is generated. In the examples described below, this indexing object is labeled as an “idx” object. The indexing object is useful when the pointer variable is dereferenced into arrays. In some embodiments, the indexing object is generated even when the pointer variable points to a scalar (non-array) object. In this case, the indexing object can be assigned a value of “0” or other null value. As more fully illustrated below, when the pointer variable points to an array object, the indexing object can also be used for pointer arithmetic (e.g., increment or decrement operations).

In certain embodiments, when a dereferencing operator is encountered as part of method act 314, a SIF statement for creating a suitable multiplexer or demultiplexer to implement the dereferencing operation is generated. In particular embodiments, and as shown as method act 318, when a dereferencing operator is encountered in an assignment statement (e.g., a=*b), a multiplexer statement for a multiplexer capable of assigning the values from all addressable objects identified in the memory map is generated. That is, the multiplexer statement initially allows all possible objects to be assigned, including objects that in fact are not valid according to the C++ description. In other embodiments, the multiplexer statements generated include other numbers of addressable objects that are greater than necessary. All such multiplexer statements are termed “inclusive multiplexer statements” herein and include multiplexer statements for multiplexers and demultiplexers.

At 316, the initial SIF statements are modified (or optimized) by removing the parameters from the initial multiplexer statements that are not valid. In one embodiment, to determine the proper multiplexer and demultiplexer statements, the initial SIF statements generated at 314 are evaluated to determine all possible values that can be assigned to the pointers in the C++ description. This analysis can be performed, for example, by evaluating the SIF statements assigning pointers to a value and the accompanying index object assignments in the initial SIF code.

FIGS. 4A-E through 8A-E are examples illustrating the application of the method 300 to various C++ descriptions. Each example includes the C++ description being converted into SIF format (FIGS. 4A-8A), an exemplary memory map generated during method act 312 (FIGS. 4B-8B), exemplary pseudo-code for the initial SIF statements generated during method act 314 (FIGS. 4C-8C), exemplary pseudo-code for the optimized SIF statements generated during method 316 (FIGS. 4D-8D), and an exemplary schematic block diagram showing the hardware described by the corresponding optimized MUX or DEMUX statements (FIGS. 4E-8E).

FIGS. 4A-4E illustrate an example showing a simple pointer reassignment and a dereference operation. The C++ description 400 at FIG. 4A includes a line 410 where integer variables a and b and Boolean variable c are declared for the procedure named “test”. At line 412, a pointer variable p is declared and assigned the address of variable a. Lines 414 indicate that if Boolean variable c is true, then the pointer variable p is to be assigned the address of variable b. Line 416 includes a dereferencing operation and indicates that the value pointed to by pointer p should be returned by the procedure.

The memory map in FIG. 4B illustrates the application of method act 312. In particular, memory map 420 shows that each of the variable objects in the C++ description 400 are assigned a unique address (e.g., using a data structure generated during the parsing operation or by evaluating each line of the C++ description). In particular, variables a, b, c, and p are assigned addresses 0x1, 0x2, 0x3, and 0x4, respectively. (Note that in this example address 0x0 is automatically assigned the null value.)

The initial SIF pseudo-code 460 in FIG. 4C illustrates the application of method act 314. In particular, the pseudo-code shows that initial SIF statements are generated for each pointer declaration and statement encountered in the C++ description 400. In particular, lines 461 and 462 are generated when the declaration of pointer variable p is encountered at line 412. Line 461 indicates that in accordance with the statement at line 412, the SIF variable p_ptr is assigned the address 0x1 (the memory map address of variable a). Line 462 indicates that an index object for pointer variable p (p_idx) is assigned the value 0 (because the integer variable a is a scalar). Lines 463 are generated to implement the IF/THEN statement from line 414. In particular, lines 463 indicate that if boolean variable c is not equal to 0, then the SIF variable p_ptr is assigned the address 0x2 (the memory map address of variable b). Line 464 generates a multiplexer to implement the dereferencing operation of line 416. In particular, the dereferencing operation of line 416 indicates that the variable returned by this procedure should be the value pointed to by pointer p (which is either a or b depending on whether c is “1” or “0”). According to one implementation, an initial SIF statement for creating a multiplexer capable of returning any of the variables is created.

It is known that certain data types cannot be pointed to by the pointer (e.g., because of a conflict in the data types), so the initial SIF statement may include one or more “don't care” variables. For example, in the illustrated embodiment, the initial SIF statement for the dereferencing operator statement includes “don't care” (“dc”) designations for the null pointer, the Boolean variable c, and for the pointer itself. In the example illustrated in FIG. 4C, the resulting SIF statement is MUX (dc, a, b, dc, dc, p_ptr). In the MUX statements set forth in this disclosure, the MUX statement includes n parameters. The first through the (n-1)th parameter correspond to the inputs into the multiplexer and the nth parameter corresponds to the selector for the multiplexer. It should be understood, of course, that other intermediate formats may use other definitions, parameters, and syntaxes.

The optimized SIF pseudo-code 470 in FIG. 4D illustrates the application of method act 316. In particular, the pseudo-code 470 shows the SIF statements after being optimized to include only the values that are actually possible. In this particular example, the “don't care” variables are eliminated from the MUX statement because they are not valid values, resulting in the optimized MUX statement 471: MUX (a, b, p_ptr).

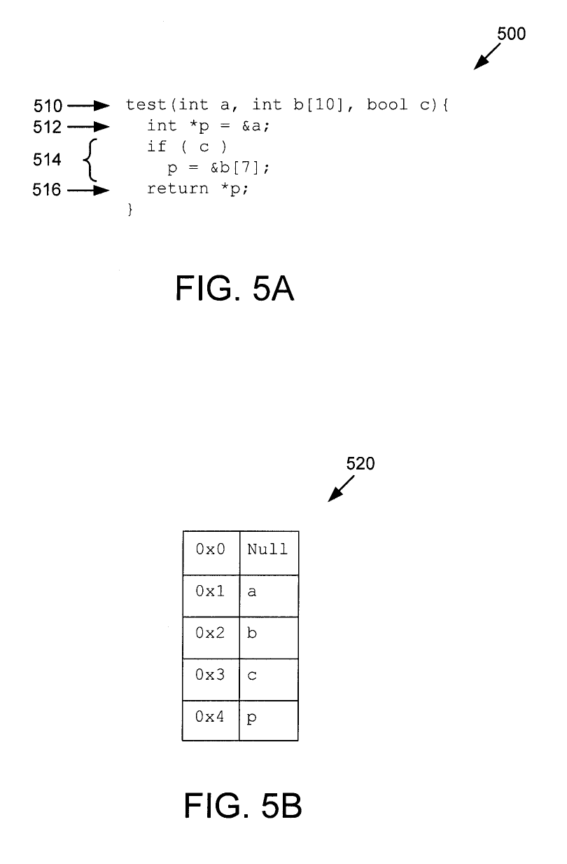

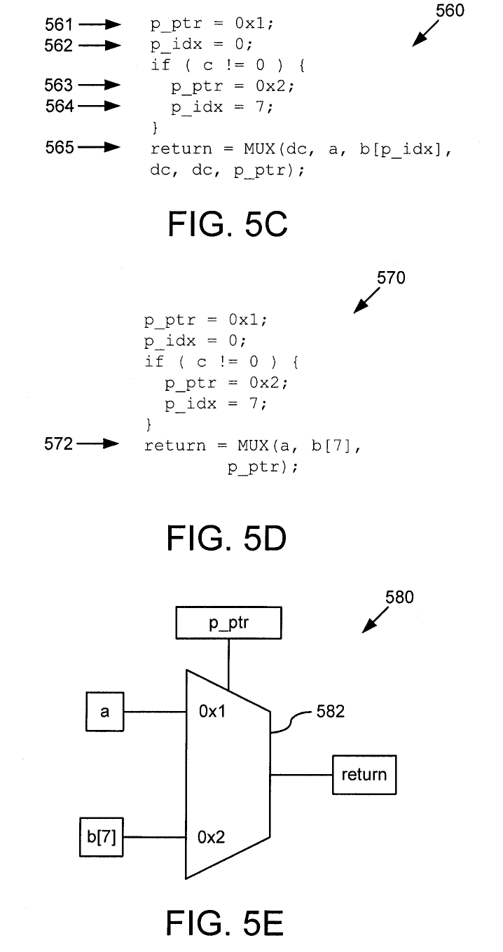

The schematic block diagram 480 shown in FIG. 4E shows the hardware corresponding to the optimized MUX statement 471. It should be noted that the hardware shown in FIG. 4E (and in FIGS. 5E-8E and 10E) is simplified in some respects in order to more clearly illustrate the concepts of the disclosed technology. For instance, the hardware is not shown in the context of an entire design, which would typically include additional hardware for inputting and outputting the variables into and out of the multiplexer.

The schematic block diagram 480 shows a 2-to-1 multiplexer 482 for returning the variable pointed to by p, which is either a or b. Furthermore, the multiplexer 482 is controlled by a single control signal having two possible values corresponding to the address for variable a (0x1) or the address for variable b (0x2).

FIGS. 5A-5E illustrate an example showing a pointer reassignment to an array variable and a dereference operation. The C++ description 500 at FIG. 5A includes a line 510 where integer variable a, integer array variable b, and Boolean variable c are declared for the procedure named “test”. At line 512, a pointer variable p is declared and assigned the address of variable a. Lines 514 indicate that if Boolean variable c is true, then the pointer variable p is to be assigned the address of the integer of array variable b at index 7. Line 516 includes a dereferencing operation and indicates that the value pointed to by p should be returned by the procedure.

The memory map in FIG. 5B illustrates the application of method act 312. In particular, memory map 520 shows that each of the variable objects in the C++ description 500 are assigned a unique address (e.g., using a data structure generated during the parsing operation or by evaluating each line of the C++ description). In particular, variables a, b, c, and p are assigned addresses 0x1, 0x2, 0x3, and 0x4, respectively. (Note that in this example address 0x0 is automatically assigned the null value.)

The initial SIF pseudo-code 560 in FIG. 5C illustrates the application of method act 314. In particular, the pseudo-code shows that SIF statements are generated for each pointer declaration and statement encountered in the C++ description 500. In particular, lines 561 and 562 are generated when the assignment of pointer variable p is encountered at line 512. Line 561 indicates that in accordance with the statement at line 512, the SIF variable p_ptr is assigned the address 0x1 (the memory map address of variable a). Line 562 indicates that an index object for pointer variable p (p_idx) is assigned the value 0 (because the integer variable a is a scalar). Lines 563 and 564 are generated to implement the IF/THEN statement from line 514. In particular, line 563 indicates that if boolean variable c is not equal to 0, then the SIF variable p_ptr is assigned the address 0x2 (the memory map address of variable b). Further, because variable b is an array variable, the index object at line 564 is initialized to indicate the particular index of the array variable b that pointer p is to point to. In this example, the index object p_idx is assigned the value 7. Line 565 generates a multiplexer to implement the dereferencing operation of line 516. In particular, the dereferencing operation of line 516 indicates that the variable returned by this procedure should be the value pointed to by pointer p (which is either a or b[7] depending on whether c is “1” or “0”). According to one implementation, an initial SIF statement for creating a multiplexer capable of returning any of the variables (as well as any value within an array variable) is created. As with the example in FIG. 4, it is known that certain data types cannot be pointed to by the pointer (e.g., because of a conflict in the data types), so the SIF statement may include one or more “don't care” variables. In the example illustrated in FIG. 5C, the resulting initial SIF statement is: MUX (dc, a, b[p_idx], dc, dc, p_ptr).

The optimized SIF pseudo-code 570 in FIG. 5D illustrates the application of method act 316. In particular, the pseudo-code shows the SIF statements after being optimized to include only the values that are actually possible. In this particular example, the “don't care” variables are eliminated from the MUX statement because they are not valid values. Furthermore, the initial SIF pseudo-code 560 is evaluated to determine all possible values that can be assigned to pointer p. This analysis can be performed, for example, by evaluating all p_ptr assignments and accompanying index object assignments in the initial SIF code. In this particular example, the analysis indicates that the pointer p can only have two values: a and b[7]. Accordingly, the optimized MUX statement 572 is as follows: MUX (a, b[7], p_ptr).

It should be noted that by initially creating an inclusive (or comprehensive) multiplexer statement, the method 300 accounts for situations when all possible pointer values are not immediately apparent until the entire C++ description has been considered. For example, the C++ description may include one or more loops that involve reassignments after an initial dereference operation is performed. As a particular example, the C++ description may include a loop that comprises a dereference operation followed by a reassignment of where the pointer points to. When the dereference operation is first encountered during the initial pass through the C++ description, the reassignment is not yet known. Thus, it is desirable to generate a MUX statement that allows the multiplexer implementing the dereference operation to select from among all various possible objects so that later pointer reassignments in the C++ description can be properly accounted for.

The schematic block diagram 580 shown in FIG. 5E shows the hardware corresponding to the exemplary optimized SIF statement 572. The schematic block diagram 580 shows a 2-to-1 multiplexer 582 for returning one of two values: a or b[7]. Furthermore, the multiplexer is controlled by a single control signal having two possible values corresponding to the address for variable a (0x1) or the address for array variable b (0x2).

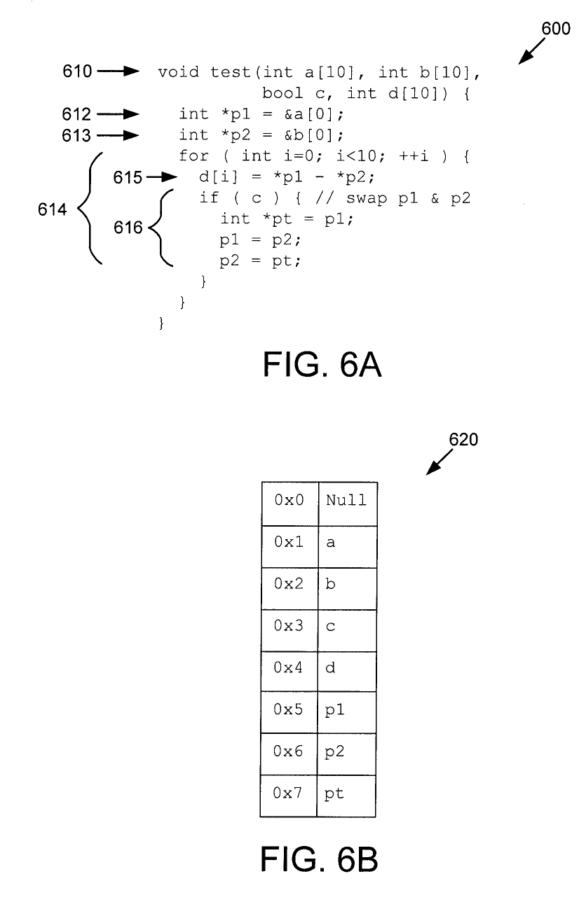

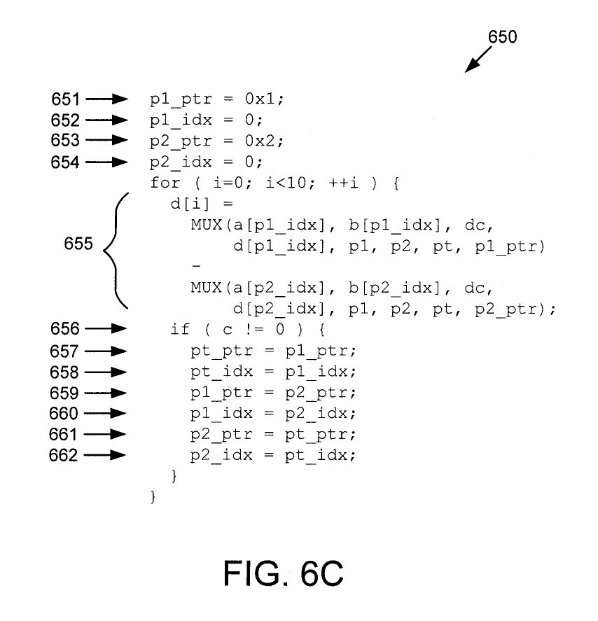

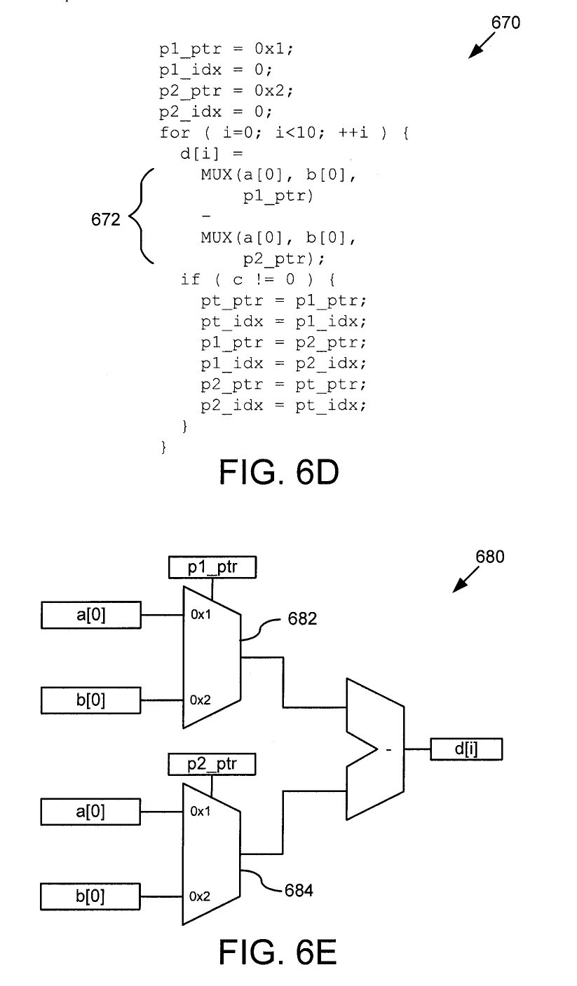

FIGS. 6A-6E illustrate an example showing a pointer reassignment from another pointer. The C++ description 600 at FIG. 6A includes a line 610 where integer array variable a, integer array variable b, and Boolean variable c, and integer array variable d are declared for the procedure named “test”. At line 612, a pointer variable p1 is declared and assigned the address of variable a at index 0. At line 613, a pointer variable p2 is declared and assigned the address of variable b at index 0. Lines 614 indicate that the various integers in the array variable d are to be assigned the difference between the integers pointed to by the array variables p1 and p2. That is, d[0] is to be assigned the value of a[0]−b[0], d[1] is also to be assigned the value of a[0]−b[0], and so on. This action is performed by line 615, which includes two dereferencing operations. Lines 614 also indicate that if the Boolean variable c is true, then the pointer variables p1 and p2 are to be swapped for purposes of determining the difference in the next iteration of the FOR loop. That is, if c is true, then the subtrahend and the subtractor are swapped for the next iteration (e.g., d[0]=a[0]−b[0], d[0]=b[0]−a[0], d[2]=a[0]−b[0] and so on). This swapping procedure is performed by lines 616, which create a new pointer pt used to store the contents of pointer p1 so that pointer p1 can be reassigned the values of pointer p2. Pointer p2 is then assigned the value of pointer pt.

The memory map 620 in FIG. 6B illustrates the application of method act 312. In particular, memory map 620 shows that each of the variable objects in the C++ description 600 is assigned a unique address (e.g., using a data structure generated during the parsing operation or by evaluating each line of the C++ description).

The initial SIF pseudo-code 650 in FIG. 6C illustrates the application of method act 314. In particular, the pseudo-code shows that SIF statements are generated for each pointer declaration and statement encountered in the C++ description 600. In particular, lines 651 and 652 are generated when the declaration of pointer variable p1 is encountered at line 612. Line 651 indicates that in accordance with the statement at line 612, the SIF pointer variable p1_ptr is assigned the address 0x1 (the memory map address of array variable a). Also in accordance with line 612, line 652 indicates that an index object for the SIF pointer variable p1_ptr (p1_idx) is assigned the value 0. Lines 653 and 654 are generated when the declaration of pointer variable p2 is encountered at line 613. Line 653 indicates that in accordance with the statement at line 612, the SIF pointer variable p2_ptr is assigned the address 0x2 (the memory map address of array variable b). Also in accordance with 613, line 654 indicates that an index object for the SIF pointer variable p2_ptr (p2_idx) is assigned the value 0.

Lines 655 are generated to implement the iterative FOR loop from line 614. In particular, and in order to implement the dereferencing operations from line 615, two inclusive MUX statements are generating for creating two multiplexers that produce the values that are subtracted from one another. The initial MUX statements are inclusive and allow the multiplexers to generate all possible values (including, for example, all values of array variable a and all values of array variable b). In particular embodiments, the inclusive MUX statements are generated as the dereferencing operations from the C++ description are encountered and without analysis or evaluation of all lines of the C++ description.

Lines 656 through 662 are generated when the declaration of pointer variable pt and the reassignments of pointers p1 and p2 are encountered at lines 616. Line 657 indicates that if c is true (if c is 1), then the SIF pointer variable pt_ptr is assigned the value of p1_ptr (that is, the address 0x1, which is the memory map address of array variable a). Line 658 indicates that an index object for the SIF pointer variable pt_ptr (pt_idx) is assigned the value of the index object for the SIF pointer variable p1_ptr (p1_idx). Line 659 indicates that the SIF pointer variable p1_ptr is assigned the value of p2_ptr (that is, the address 0x2, which is the memory map address of array variable b). Line 660 indicates that the index object for the SIF pointer variable p1_ptr (p1_idx) is assigned the value of the index object for the SIF pointer variable p2_ptr (p2_idx). Line 661 indicates that the SIF pointer variable p2_ptr is assigned the value of pt_ptr (that is, the address 0x1, which is the memory map address of array variable a). Line 662 indicates that an index object for the SIF pointer variable p2_ptr (p2_idx) is assigned the value of the index object for the SIF pointer variable pt_ptr (pt_idx), thus completing the swap.

The optimized SIF pseudo-code 670 in FIG. 6D illustrates the application of method act 316. In particular, the pseudo-code shows the SIF statements after being optimized to include only the values that are actually possible. In this particular example, the “don't care” variables are eliminated from the MUX statements because they are not valid values. Furthermore, the initial SIF pseudo-code 650 is evaluated to determine all possible values that can be assigned to pointers p1 and p2 (e.g., by evaluating the SIF pointer variable assignments). In this example, this analysis indicates that the pointers p1 and p2 can each potentially point to each of the integers in array variables a and b at index 0. The MUX statements are optimized accordingly, resulting in the following statements: MUX(a[0], b[0], p1_ptr)−MUX(a[0], b[0], p2_ptr).

The schematic block diagram 680 shown in FIG. 6E shows the hardware corresponding to the optimized SIF statement 672. In relevant part, multiplexers 682, 684 are capable of outputting either a[0] or b[0] based on the value of control signal p1_ptr and p2_ptr, respectively.

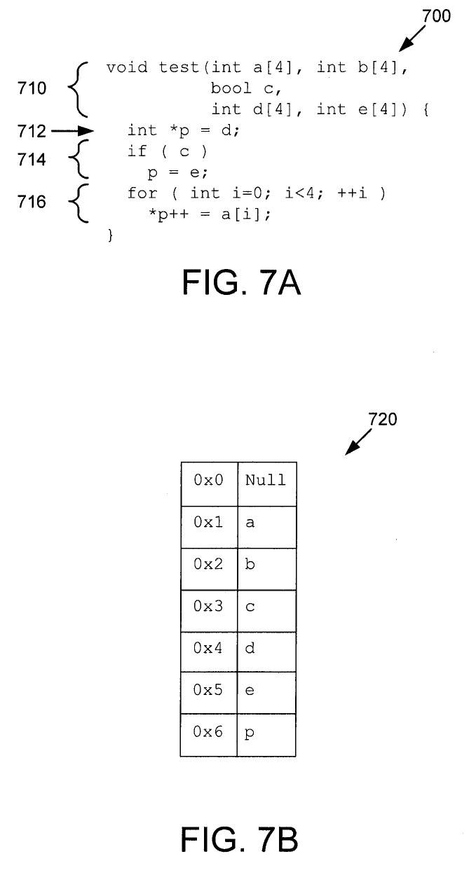

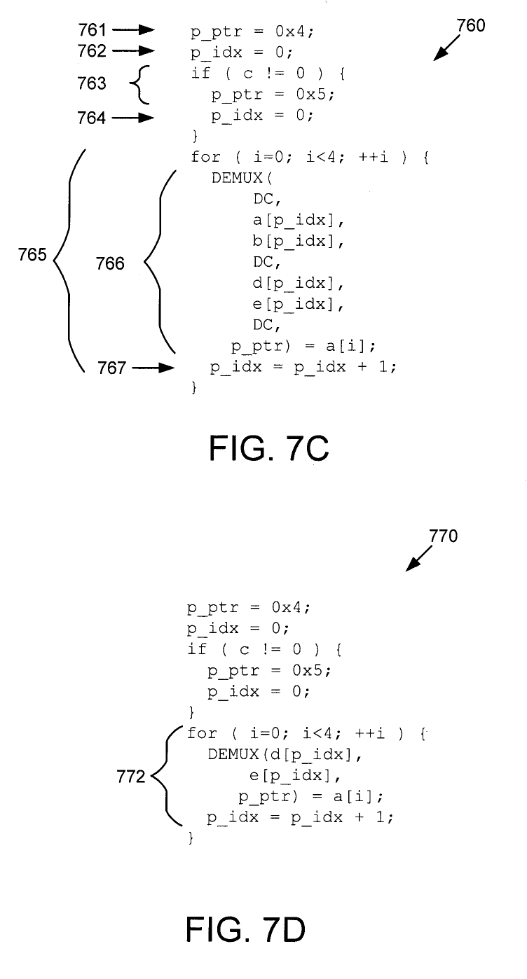

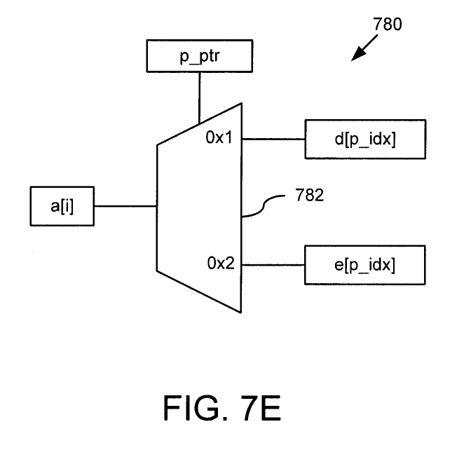

FIGS. 7A-7E illustrate an example showing pointer dereference, assignment, and increment operations. The C++ description 700 at FIG. 7A includes a line 710 where integer array variable a, integer array variable b, Boolean variable c, integer array variable d, and integer array variable e are declared for the procedure named “test”. At line 712, a pointer variable p is declared and assigned the address of variable d. (According to C++ syntax, when a pointer is assigned to an array variable without specifiying an index value, as in line 712, then the pointer is deemed to point to the value at the 0th index by default.) Lines 714 indicate that if Boolean variable c is true, then the pointer variable p is to be assigned the address of array variable e at index 0. Lines 716 correspond to a FOR loop that assigns the integer values at indices 0 to 4 of the variable array a to the corresponding indices of the array variable that pointer p points to. In particular, the syntax “*p++ ” means that the pointer p is first dereferenced, the dereferenced element of the array that p points to is assigned the value of a[i], then the index value of the pointer is incremented so that the pointer points to the next element in the array the pointer points to. Further, because the dereferencing operation occurs on the left side of the equation, the dereferenced variable is the one being assigned a new value. This type of dereferencing operation can be implemented in hardware using a demultiplexer.

The memory map in FIG. 7B illustrates the application of method act 312. In particular, memory map 720 shows that each of the variable objects in the C++ description 700 are assigned a unique address. In particular, variables a, b, c, d, e, and p are assigned addresses 0x1, 0x2, 0x3, 0x4, 0x5, and 0x6, respectively. (Note that in this example address 0x0 is automatically assigned the null value.)

The initial SIF pseudo-code 760 in FIG. 7C illustrates the application of method act 314. In particular, the pseudo-code shows that SIF statements are generated for each pointer declaration and statement encountered in the C++ description 700. In particular, lines 761 and 762 are generated when the declaration of pointer variable p is encountered at line 712. Line 761 indicates that in accordance with the statement at line 712, the SIF variable p_ptr is assigned the address 0x4 (the memory map address of variable d). Line 762 indicates that an index object for pointer variable p (p_idx) is assigned the value 0. Lines 763 and 764 are generated to implement the IF/THEN statement from line 714. In particular, line 763 indicates that if Boolean variable c is not equal to 0 (c=1), then the SIF variable p_ptr is assigned the address 0x5 (the memory map address of variable e). Line 764 indicates that an index object for pointer variable p (p_idx) is assigned the value 0. Lines 765 implement the FOR loop. In particular, line 766 generates a demultiplexer to implement the dereferencing operation of line 716. The dereferencing operation of line 716 indicates that the variable returned by this procedure should be assigned the value of the array variable at the current index. According to one implementation, an initial SIF statement for creating a demultiplexer capable of assigning any of the variables to the variable pointed to by pointer d is created. As with the example in FIG. 4, it is known that certain data types cannot be pointed to by the pointer (e.g., because of a conflict in the data types), so the SIF statement may include one or more “don't care” variables as shown in FIG. 7C. Furthermore, in particular implementations, the DEMUX statement initially allows the demultiplexer to select all values of the array variables declared in the C++ description. In the example illustrated in FIG. 7C, the resulting initial SIF statement is: DEMUX (dc, a[p_idx], b[p_idx], dc, d[p_idx], e[p_idx], dc, p_ptr). Line 767 implements the increment operation from line 716. In particular, line 767 indicates that the value of the index object p_idx should be increased by 1.

The optimized SIF pseudo-code 770 in FIG. 7D illustrates the application of method act 316. In particular, the pseudo-code shows the initial SIF statements after being optimized to include only the values that are actually possible. In this particular example, the “don't care” variables are eliminated from the DEMUX statement because they are not valid values. Furthermore, the initial SIF pseudo-code 760 is evaluated to determine all possible values that can be assigned to pointer p. This analysis can be performed, for example, by evaluating all p_ptr assignments and accompanying index object assignments in the initial SIF code. In this particular example, the analysis indicates that the pointer p can point to only two array variables: d and e. Accordingly, the optimized DEMUX statement 772 is as follows: DEMUX (d[p_idx], e[p_idx], p_ptr).

The schematic block diagram 780 shown in FIG. 7E shows the hardware corresponding to the dereferencing operation shown at line 772. The schematic block diagram 780 shows a 1-to-2 demultiplexer 782 for loading the array variable a with an integer from one of two array variables d or e according to the value of the index object p_idx and the pointer variable p_ptr.

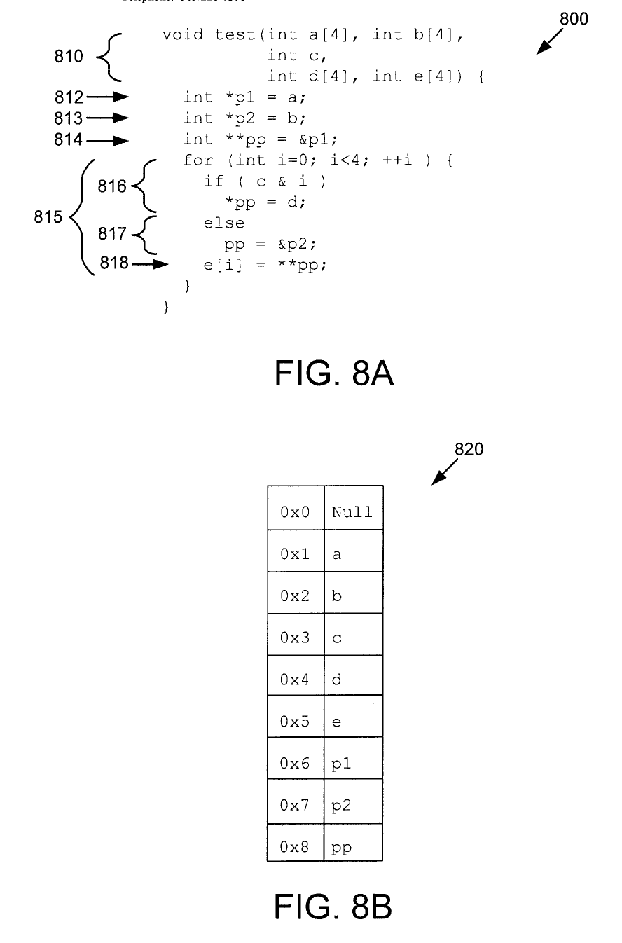

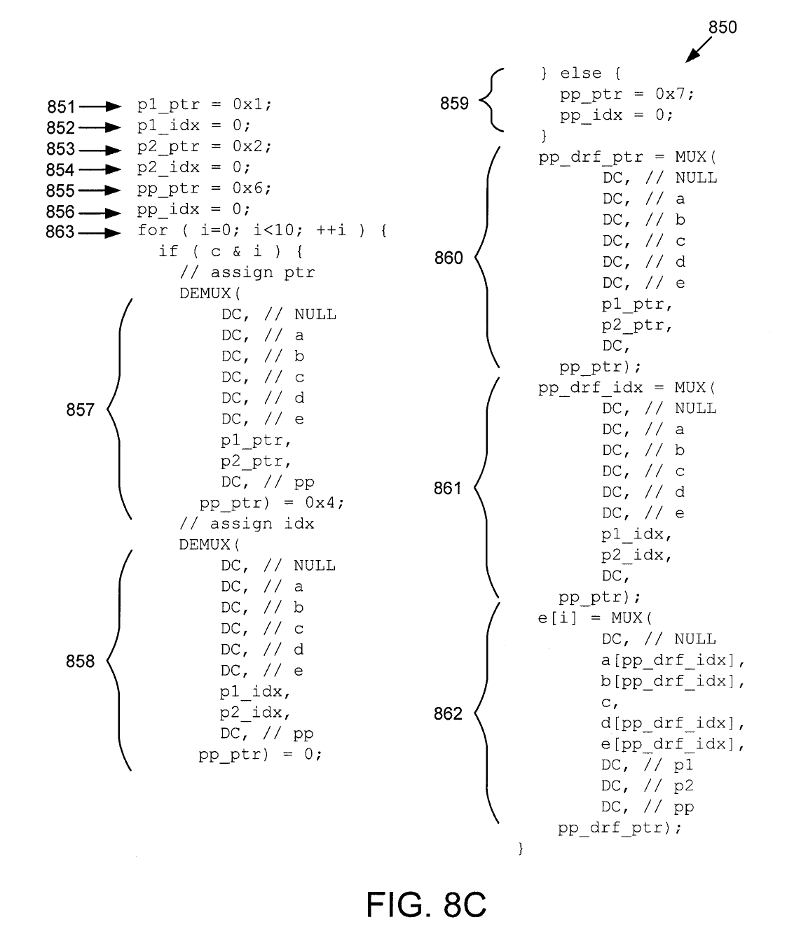

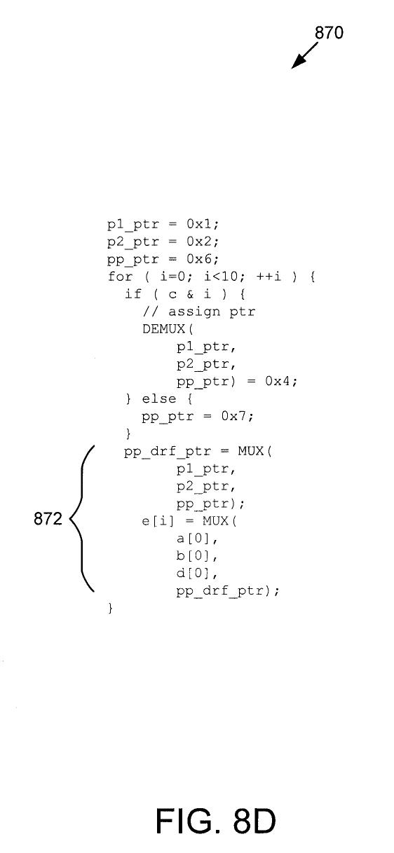

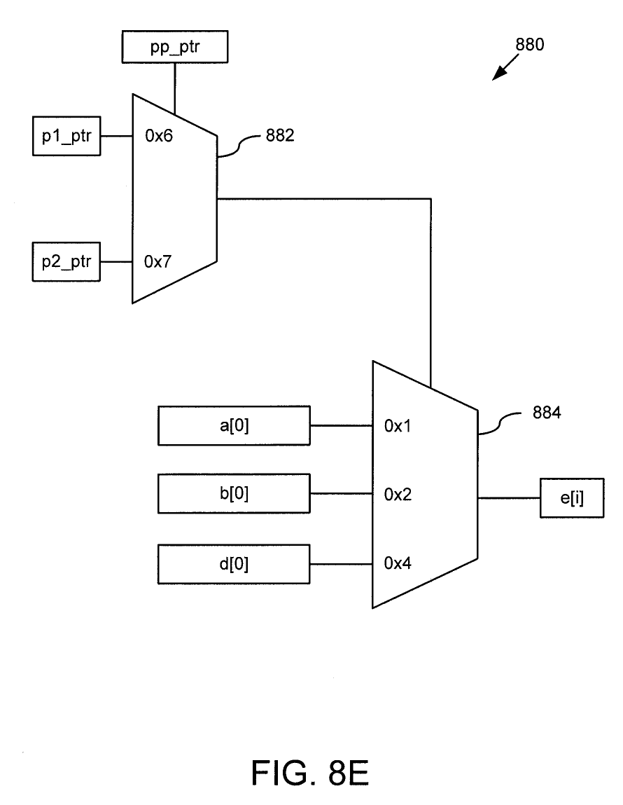

FIGS. 8A-8E illustrate an example showing a pointer-to-pointer assignment. The C++ description 800 at FIG. 8A includes a line 810 where integer array variable a, integer array variable b, and Boolean variable c, integer array variable d, and integer array variable e are declared for the procedure named “test”. At line 812, a pointer variable p1 is declared and assigned the address of array variable a at index 0. At line 813, a pointer variable p2 is declared and assigned the address of array variable b at index 0. At line 814, a pointer that points to another pointer (pp) is declared and initially assigned to the address of the pointer p1. When dereferenced once (“*pp”), the pointer pp returns the value stored by the pointer to which it points (initially, this is the value assigned to p1, which is the address of a at index 0). When dereferenced twice (“**pp”), pointer pp returns the value stored at the address pointed to by the pointer that pointer pp points to (initially, this is the value stored at a[0]). Lines 815 represent a FOR loop that is iterated four times. Lines 816 within the FOR loop indicate that if the value of c returns a “true” result when it is compared through a bitwise AND operation with the value of i, then the pointer pointed to by pointer pp is to be reassigned to the address of array variable d at index 0. Otherwise, and as indicated by line 817, the pointer pp is to be reassigned to the address of the pointer p2. Line 818 within the FOR loop assigns the array variable e at the current index i the value of pointer pp after being dereferenced twice, thus assigning to e the value that is pointed to by the pointer to which pp currently points (which corresponds to the value pointed to by either pointer p1 or p2).

The memory map 820 in FIG. 8B illustrates the application of method act 312. In particular, memory map 820 shows that each of the variable objects in the C++ description 800 is assigned a unique address (e.g., using a data structure generated during the parsing operation or by evaluating each line of the C++ description).

The initial SIF pseudo-code 850 in FIG. 8C illustrates the application of method act 314. In particular, the pseudo-code shows that SIF statements are generated for each pointer declaration and statement encountered in the C++ description 800. In particular, lines 851 and 852 are generated when the declaration of pointer variable p1 is encountered at line 812. Line 851 indicates that in accordance with the statement at line 812, the SIF pointer variable p1_ptr is assigned the address 0x1 (the memory map address of array variable a). Also in accordance with line 812, line 852 indicates that an index object for the SIF pointer variable p1_ptr (p1_idx) is assigned the value 0. Lines 853 and 854 are generated when the declaration of pointer variable p2 is encountered at line 813. Line 853 indicates that in accordance with the statement at line 812, the SIF pointer variable p2_ptr is assigned the address 0x2 (array variable b). Also in accordance with 813, line 854 indicates that an index object for the SIF pointer variable p2_ptr (p2_idx) is assigned the value 0. Lines 855 and 856 are generated when the declaration of pointer variable pp is encountered at line 814. Line 855 indicates that in accordance with the statement at line 814, the SIF pointer variable pp_ptr is assigned the address 0x6 (pointer p1). Also in accordance with 814, line 856 indicates that an index object for the SIF pointer variable pp_ptr (pp_idx) is assigned the value 0.

Line 863 is generated to implement the iterative FOR loop from line 815. In particular, and in order to implement the dereferencing operations from line 816, two inclusive DEMUX statements (statements 857 and 858) are generated for assigning the pointer pointed to by pp the value at memory map address 0x4 (array variable d) and the corresponding pointer index a value of 0. The initial DEMUX statements for both the pointer object and the pointer index object are inclusive and allow the demultiplexers to select all possible values.

Lines 859 are generated to implement the ELSE statement from line 817. In particular, line 859 indicates that the pointer pp is to be assigned the value of memory address 0x7 (pointer p2) and that the index of pp is to be assigned the value of 0.

Lines 860 through 862 are generated to implement the pointer-to-pointer dereferencing at line 818. In particular, because line 818 includes a double dereferencing operation, multiple multiplexer statements are generated to implement the operation. Line 860 and 861 are generated to implement the first dereferencing operation of line 818. In this example, lines 860 correspond to an inclusive MUX statement that assigns an object corresponding to the pointer pp any of the possible values (including the values of p1_ptr and p2_ptr) after a single dereference operation. Lines 861 are generated so that the corresponding index object for pp_drf_ptr (pp_drf_idx) is also properly assigned. Line 862 is generated to implement the second dereferencing operation of line 818. In particular, line 862 generates an inclusive MUX statement that assigns the array variable e any possible value from the available addressable objects and uses the pp_drf_ptr object as the selector. As above, the initial MUX statements for both the pointer objects and the pointer index objects are inclusive and allow the multiplexers to select all possible values.

The optimized SIF pseudo-code 870 in FIG. 8D illustrates the application of method act 316. In particular, the pseudo-code shows the SIF statements after being optimized to include only the values that are actually possible. In this particular example, the “don't care” variables are eliminated from the DEMUX and MUX statements because they are not valid values. Furthermore, the initial SIF pseudo-code 850 is evaluated to determine all possible values that can be assigned to pointers p1, p2, and pp (e.g., by evaluating the SIF pointer variable assignments). In this example, this analysis indicates that the pointer p1 can potentially point to array variable a at index 0 or array variable d at index 0, pointer p2 can potentially point to array variable b at index 0 or array variable d at index 0, and pointer pp can potentially point to pointer p1 or p2. The DEMUX and MUX statements are optimized accordingly. In particular, optimized SIF statements 872 allow for the mux implementing the second dereferencing operation to assign either a[0], b[0], or d[0] to e[i] based on the value of the selector, which is either p1 or p2. Furthermore, the assignment, DEMUX, and MUX statements for the index objects (p1_idx, p2_idx, and pp_idx) are optimized away as they are not actually used in this example.

The schematic block diagram 880 shown in FIG. 8E shows the hardware corresponding to the optimized SIF statements 872. In relevant part, multiplexer 882 implements the first dereferencing operation of pp and selects either p1_ptr or p2_ptr and multiplexer 884 implements the second dereferencing operation by assigning e[i] either a[0], b[0], or d[0] based on the value of either p1_ptr or p2_ptr. For clarity, the hardware for assigning variable pp_ptr is not shown.

FIG. 9 is a flow chart illustrating a second exemplary method 900 for handling pointers during the conversion process. The illustrated embodiment results in a conversion of the C++ description containing the pointers into a corresponding SIF description, but it should be understood that the principles underlying the conversion process can be readily applied to other conversion processes, such as C++ to VHDL or other HDL. The exemplary method shown in FIG. 9 should not be construed as limiting in any way. For example, in other embodiments of the disclosed technology, only a subset of the illustrated method acts are performed. In still other embodiments, any of the method acts are performed alone or in other combinations and subcombinations with one another or with other synthesis acts.

At 910, an algorithmic description (e.g., a C++ description, such as a parsed C++ description) including one or more pointers is received (e.g., loaded or buffered) as in method act 310.

At 912, the addressable objects in the algorithmic description (e.g., the C++ description) are identified and assigned a unique value in a first pass as in method act 312.

At 914, the synthesis intermediate format statements representing the C++ description are generated in a fashion similar to method 314 during a second pass. In this embodiment, however, when a dereferencing operator is encountered, a SIF statement is generated that serves as a placeholder for a multiplexer or demultiplexer. In other words, a temporary object (the placeholder object) is generated that indicates that an instance of a dereferencing operation for a particular pointer is to occur. It should be noted that this embodiment is not entirely dissimilar from method 300 and can be viewed as broader than method 300 in certain respects. For example, in certain particular implementations, the placeholder statements inserted at method act 914 are MUX or DEMUX statements that are replaced during method act 916 with more accurate statements.

At 916, the placeholder objects are replaced with appropriate multiplexer or demultiplexer statements during a third pass. To determine the proper multiplexer and demultiplexer statements, the initial SIF pseudo-code can be evaluated to determine all possible values that can be assigned to the pointers. This analysis can be performed, for example, by evaluating the SIF statements assigning pointers to a value and the accompanying index object assignments from the initial SIF statements.

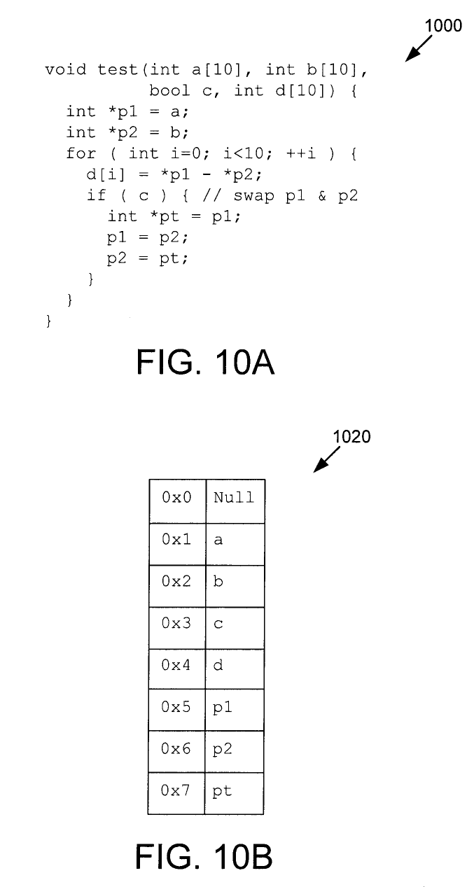

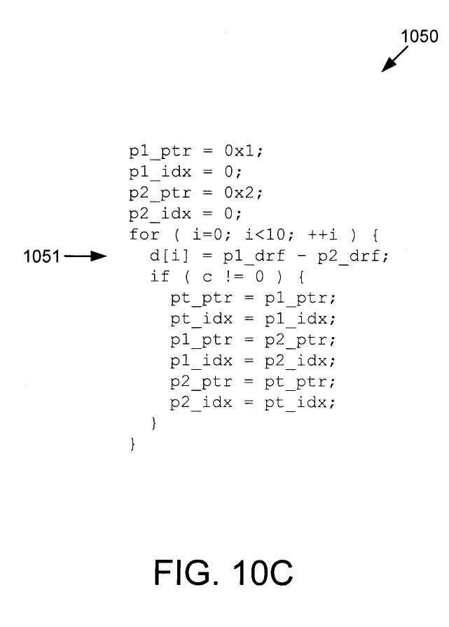

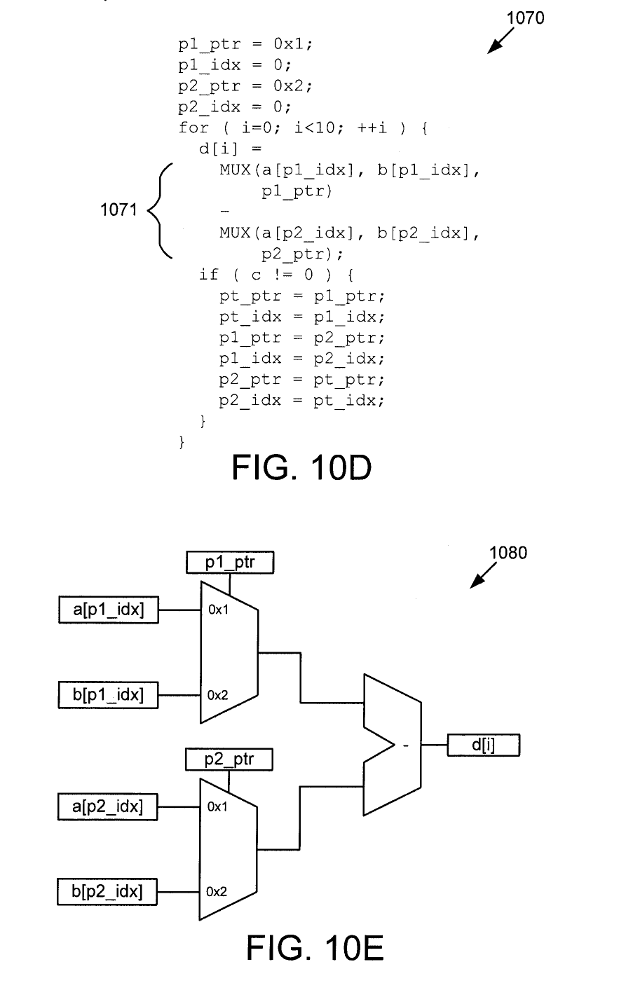

FIGS. 10A-E illustrate an example of the application of the method 900 to an exemplary C++ description. The C++ description 1000 in FIG. 10A is identical to that shown in FIG. 6A. FIG. 10B shows the memory map generated at method act 912 and is identical to the memory map from FIG. 6B. FIG. 10C illustrates the application of method 614 to the exemplary C++ description 1000. The initial SIF pseudo-code 1050 is identical to that shown in FIG. 6C except that at line 1051 a SIF statement including the placeholders objects is produced. In this particular example, the placeholder objects are “p1_drf” and “p2_drf”.

The optimized SIF pseudo-code 1070 in FIG. 10D illustrates the application of method act 1016. In particular, the pseudo-code shows the SIF statements after the placeholder statements have been replaced with appropriate MUX statements. In this particular example, the initial SIF pseudo-code 1050 is evaluated to determine all possible values that can be assigned to pointers p1 and p2 (e.g., by evaluating the SIF pointer variable assignments and accompanying index objects). This analysis indicates that the pointers p1 and p2 can each potentially point to the integers at the 0th index in array variables a and b. The optimized MUX statements 1071 are generated accordingly, resulting in the following: MUX(a[0], b[0], p1_ptr)−MUX(a[0], b[0], p2_ptr).

The schematic block diagram 1080 shown in FIG. 10E shows the hardware generated by the exemplary optimized statements 1071.

### IV. Exemplary Network Environments for Applying the Disclosed Techniques

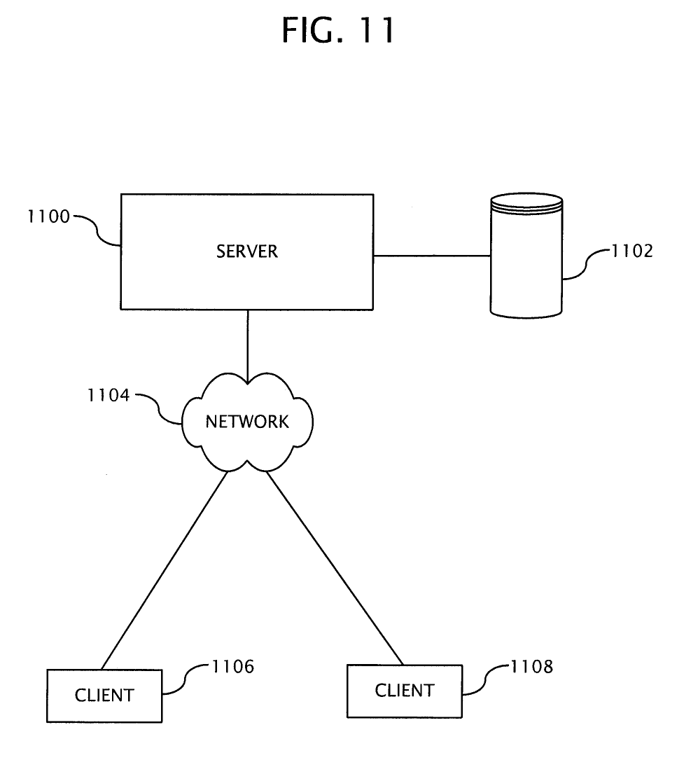

Any of the aspects of the technology described above may be performed using a distributed computer network. FIG. 11 shows one such exemplary network. A server computer 1100 can have an associated storage device 1102 (internal or external to the server computer). For example, the server computer 1100 can be configured to perform an algorithmic synthesis technique according to any of the disclosed embodiments (e.g., as part of an EDA software tool, such as a C++ synthesis tool). The server computer 1100 can be coupled to a network, shown generally at 1104, which can comprise, for example, a wide-area network, a local-area network, a client-server network, the Internet, or other such network. One or more client computers, such as those shown at 1106, 1108, may be coupled to the network 1104 using a network protocol. The work may also be performed on a single, dedicated workstation, which has its own memory and one or more CPUs.

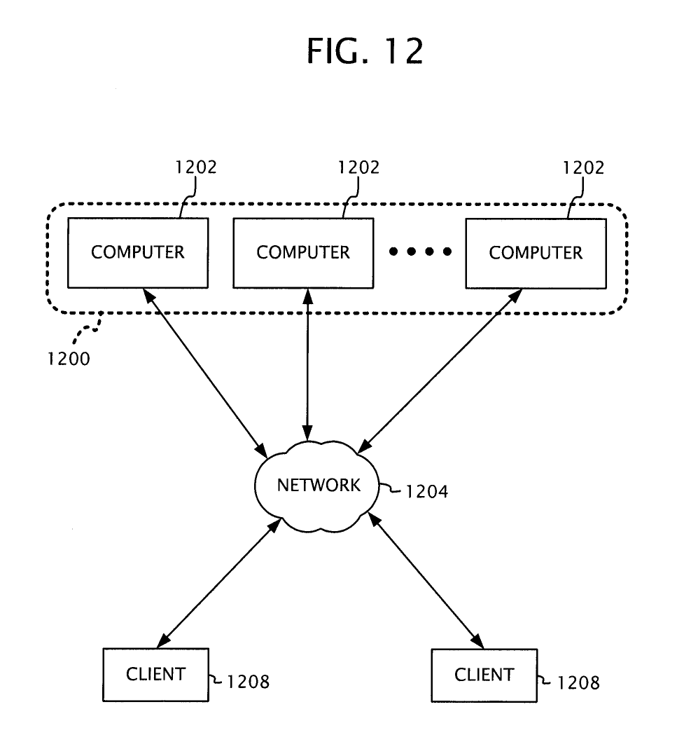

FIG. 12 shows another exemplary network. One or more computers 1202 communicate via a network 1204 and form a computing environment 1200 (e.g., a distributed computing environment). Each of the computers 1202 in the computing environment 1200 can be used to perform at least a portion of the resource allocation technique according to any of the disclosed embodiments (e.g., as part of an EDA software tool, such as a C++ synthesis tool). The network 1204 in the illustrated embodiment is also coupled to one or more client computers 1208.

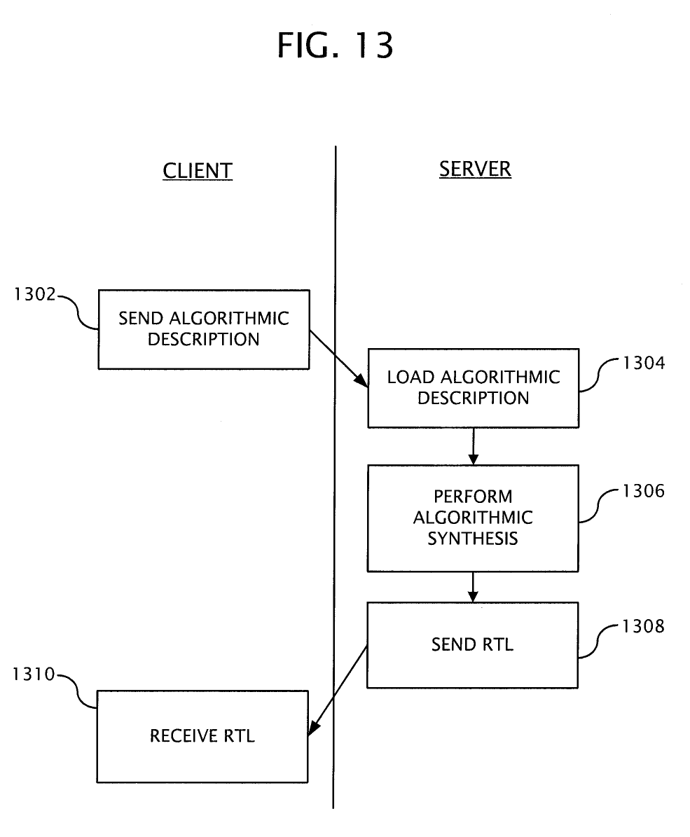

FIG. 13 shows that an algorithmic description (e.g., a C++ description of a circuit design) can be analyzed using a remote server computer (such as the server computer 1100 shown in FIG. 11) or a remote computing environment (such as the computing environment 1200 shown in FIG. 12) in order to perform algorithmic synthesis using any of the embodiments disclosed herein. At process block 1302, for example, the client computer sends the algorithmic description to the remote server or computing environment. In process block 1304, the algorithmic description is received and loaded by the remote server or by respective components of the remote computing environment. In process block 1306, synthesis is performed using any of the disclosed embodiments. At process block 1308, the remote server or computing environment sends the resulting RTL description to the client computer, which receives the data at process block 1310. It should be apparent to those skilled in the art that the example shown in FIG. 13 is not the only way to perform algorithmic synthesis using multiple computers. For instance, the algorithmic description may be stored on a computer-readable medium that is not on a network and that is sent separately to the server or computing environment (e.g., a CD-ROM, DVD, or portable hard drive). Or, the server computer or remote computing environment may perform only a portion of the algorithmic synthesis procedures.

Having illustrated and described the principles of the disclosed technology, it will be apparent to those skilled in the art that the disclosed embodiments can be modified in arrangement and detail without departing from such principles. For instance, the disclosed technology can be applied to algorithmic descriptions that define arrays of pointers as well. The pointers in an array of pointer can point, for example, to scalar variables, array variables, pointer variables, or any combination thereof. In view of the many possible embodiments to which the principles of the disclosed technologies can be applied, it should be recognized that the illustrated embodiments are only preferred examples of the technologies and should not be taken as limiting the scope of the invention. Rather, the scope of the invention is defined by the following claims and their equivalents. We therefore claim as our invention all that comes within the scope and spirit of these claims.

What is claimed is:

1. A computer-implemented method, comprising:
receiving an algorithmic description of a circuit design, the algorithmic description comprising one or more dereferencing operators, each dereferencing operator being associated with a pointer variable;
identifying addressable objects in the algorithmic description and assigning unique values to one or more of the addressable objects;
generating one or more statements describing hardware for implementing the one or more dereferencing operators, wherein the generating is performed at least in part using the unique values assigned to the one or more of the addressable objects, and wherein the hardware comprises at least one multiplexer or at least one demultiplexer; and
storing the one or more statements on a computer-readable medium.

2. The computer-implemented method of claim 1, wherein the algorithmic description is a C++ description or a parsed C++ description.

3. The computer-implemented method of claim 1, wherein the addressable objects include one or more of scalar variables, array variables, or pointer variables.

4. The computer-implemented method of claim 1, wherein the generating comprises generating an inclusive multiplexer statement for a selected one of the dereferencing operators, the inclusive multiplexer statement describing a multiplexer capable of outputting values associated with any of the addressable objects.

5. The computer-implemented method of claim 4, further comprising optimizing the inclusive multiplexer statement by removing parameters of the inclusive multiplexer statement that are not valid.

6. The computer-implemented method of claim 1, wherein one of the dereferencing operators is used in an assignment of one or more values to variables pointed to by the associated pointer variable, and wherein the generating comprises generating an inclusive multiplexer statement for the assignment, the inclusive multiplexer statement describing a demultiplexer capable of outputting the one or more values to memory addresses associated with any of the addressable objects.

7. The computer-implemented method of claim 6, further comprising optimizing the inclusive multiplexer statement by removing parameters of the inclusive multiplexer statement that are not valid.

8. The computer-implemented method of claim 1, wherein the generating comprises generating a statement for a selected one of the dereferencing operators, the statement including a temporary object that indicates an instance of a dereferencing operation for the associated pointer variable.

9. The computer-implemented method of claim 8, further comprising replacing the temporary object in the statement with a multiplexer statement or demultiplexer statement.

10. The computer-implemented method of claim 1, wherein the algorithmic description further comprises a pointer variable that points to other pointer variables and a dereferencing operation that twice dereferences the pointer variable that points to other pointer variables, the method further comprising generating one or more statements describing hardware for implementing the dereferencing operation that twice dereferences the pointer variable that point to other pointer variables, the hardware comprising two or more multiplexers.

11. The computer-implemented method of claim 1, wherein the addressable objects include one or more arrays of pointers wherein each pointer of a respective array of pointers can reference a scalar variable, array variable, or pointer variable.

12. The computer-implemented method of claim 1, wherein the method further comprises converting the statements into a register transfer level (“RTL”) circuit description.

13. One or more computer readable media storing an RTL description generated at least in part by the method of claim 12.

14. The method of claim 12, wherein the method further comprises converting the RTL circuit description into a gate-level netlist.

15. One or more computer readable media storing a gate-level netlist generated at least in part by the method of claim 14.

16. The method of claim 14, wherein the method further comprises manufacturing an integrated circuit from the gate-level netlist, the integrated circuit comprising the at least one multiplexer or the at least one demultiplexer.

17. One or more computer readable media storing computer-executable instructions for causing a computer to perform the method of claim 1.

18. One or more computer readable media storing computer-executable instructions for causing a computer to perform a method, the method comprising:
converting an algorithmic description of desired circuit functionality into a register transfer level (“RTL”) description of a circuit for implementing the desired circuit functionality, wherein the algorithmic description of the desired circuit functionality comprises one or more pointer dereferencing operations, and wherein a portion of the RTL description defines one or more demultiplexers for implementing at least one of the pointer dereferencing operations; and
storing the RTL description of the circuit on a computer-readable medium.

19. The one or more computer readable media of claim 18, wherein the converting comprises converting the algorithmic description into an intermediate description, the intermediate description comprising one or more statements defining the one or more demultiplexers.

20. The one or more computer readable media of claim 18, wherein the converting comprises generating a hardware description statement describing a demultiplexer for a selected one of the dereferencing operations, the selected dereferencing operation being associated with a respective pointer.

21. The one or more computer readable media of claim 20, wherein the method further comprises optimizing the hardware description statement so that the demultiplexer described by the hardware description statement is capable of outputting one or more values to memory addresses associated with only those variables that are actually pointed to by the respective pointer.

22. The one or more computer readable media of claim 18, wherein the converting comprises generating a hardware description statement for a selected one of the dereferencing operations, the selected dereferencing operation being associated with a respective pointer, the hardware description statement including a temporary object that indicates an instance of the dereferencing operation is to occur.

23. The one or more computer readable media of claim 18, wherein the converting further comprises replacing the temporary object in the statement with a hardware description of a demultiplexer capable of outputting one or more values to memory addresses associated with only those variables that are actually pointed to by the respective pointer.

24. The one or more computer readable media of claim 18, wherein the algorithmic description further comprises a pointer to pointer variable and a dereferencing operation that twice dereferences the pointer to pointer variable, and wherein the converting comprises generating a statement describing two or more demultiplexers for implementing the dereferencing operation that twice dereferences the pointer to pointer variable.

25. The one or more computer readable media of claim 18, wherein the method further comprises converting the RTL circuit description into a gate-level netlist.

26. The one or more computer readable media of claim 18, wherein the algorithmic description is a C++ description or a parsed C++ description.

27. One or more computer readable media storing computer-executable instructions for causing a computer to perform a method, the method comprising:
receiving a high-level description of a circuit design, the high-level description comprising one or more dynamic pointer dereferencing operations; and
converting the high-level description of the circuit design into an RTL description or a gate-level netlist, the RTL description or the gate-level netlist describing hardware capable of implementing the dynamic pointer dereferencing operations, wherein the hardware comprises one or more demultiplexers.

28. The one or more computer readable media of claim 27, wherein the high-level description is a C++ description.

29. The one or more computer readable media of claim 27, wherein the converting comprises converting the high-level description into an intermediate description, the intermediate description comprising one or more statements that define one or more demultiplexers for implementing the pointer dereferencing operations.
